(19) United States
(12) Patent Application Publication
(10) Pub. No.: US 2011/0252987 A1
(43) Pub. Date: Oct. 20, 2011

(54) REUSABLE STENCIL APPARATUS AND METHODS FOR MAKING AND USING SAME

(76) Inventor: Linda Cibula, River Forest, IL (US)

(21) Appl. No.: 12/763,848

(22) Filed: Apr. 20, 2010

(51) Int. Cl. B05C 17/06; B41M 1/12

(52) U.S. Cl. 101/128.21; 101/129

(57) ABSTRACT

A reusable stencil apparatus and methods for making and using same are provided. In a general embodiment, a stencil apparatus includes a body having front and back sides and at least one design cutout formed in the body, a removable adhesive on the back side of the body, and a release coating on the front side of the body. The stencil apparatus does not require a backing layer to prevent the adhesive from sticking to a front side of the body when the stencil apparatus is rolled up. The stencil apparatus may be removably adhered to a surface and a transfer medium applied to the stencil apparatus and surface to leave an image of the design cutout on the surface when the stencil apparatus is removed from the surface.

### BACKGROUND

The present disclosure generally relates to reusable apparatuses for transferring an image to a working surface using a transfer medium. More specifically, the present disclosure relates to stencil apparatuses, and methods of making and using same.

Home decorating is widely accepted as an enjoyable form of recreation that also helps a consumer save money on home improvement and update and/or enhance the aesthetics of a living space. Home decorating may include, for example, applying wall paper, painting or texturing surfaces, or stenciling designs onto surfaces. A variety of stenciling apparatuses are known in the art and include, for example, hand held devices that include a limited number of design cutouts therein. Such devices are not optimal for transferring designs to large surfaces, however, because the devices require constant repositioning and alignment of the device to create multiple designs on a surface. Further, human error in repositioning and aligning of the device can leave behind inconsistent design patterns when the stencil apparatus is removed from the working surface.

Another example of a stencil apparatus includes masks having a strong adhesive that include at least two layers, wherein the second layer is a liner layer that is adhered to an adhesive that coats a back side of a first layer. The liner layer is provided to prevent the adhesive from sticking to surfaces or other items prior to application to the working surface. The liner may also be provided to prevent the adhesive layer from non-releasably sticking to a top layer if the stencil apparatus is rolled during packaging and shipment. Additionally, the strong adhesive may be difficult to remove from a working surface after use and, as such, is not well adapted for repositioning to transfer designs onto large surfaces. Because strong adhesive stencil apparatuses strongly bond to surfaces in which the adhesive comes into contact, such apparatuses are also not well suited for reuse and, therefore, can be costly when the apparatus requires replacement. Such prior art stencil designs are, therefore, complicated, costly and inefficient for use with large working surfaces.

### SUMMARY

Stencil apparatuses and methods of making and using same are provided. In a general embodiment, the present disclosure provides a stencil apparatus including a body having front and back sides and at least one design cutout formed in the body, a removable adhesive on the back side of the body, and a release coating on the front side of the body. The stencil apparatus does not require a backing layer to prevent the adhesive from sticking to a front side of the body when, for example, the stencil apparatus is rolled up.

In another embodiment, a reusable stencil apparatus is provided and includes a body having front and back sides and at least one design cutout formed in the body, a removable adhesive on the back side of the body, and a release coating on the front side of the body, wherein the body does not require a backing layer to prevent the adhesive from sticking to a portion of the body.

In an embodiment, the body is formed of stock paper. The stock paper may be 6.5 mil white laser stock paper.

In an embodiment, the removable adhesive is a hot melt acrylic adhesive. The removable adhesive may form a layer on the back side of the body and may have a thickness of about 0.5 to about 2 mil. The thickness may also be about 1 mil thick.

In an embodiment, the release coating forms a layer on the front side of the body and has a thickness of about 0.1 to about 0.5 mil. The release coating layer may also be about 0.2 to 0.3 mils thick. In an embodiment, the release coating includes dimethysiloxanes and silicones.

In an embodiment, the cutouts have a shape associated with a theme including at least one of geometric, religious, animals, people, nature, vehicles, buildings, sports, food, seasonal decorations, and special occasion decorations. When the shape is associated with a geometric theme, the shape may include at least one of a circle, square, triangle, rectangle, oval, ellipse, and semi-circle. When the shape is associated with a religious theme, the shape may include at least one of a cross, bible, star of David, angels, trumpets, wreaths, fish, menorah, dove, candle, star and crescent, om, and Buddha. When the shape is associated with a sports theme, the shape may include at least one of a baseball, bat, baseball hat, baseball glove, basketball, basketball hoop, football, football goal post, football helmet, golf ball, golf club, and lacrosse stick.

In an embodiment, the cutouts may be in the shape of words or numbers. Additionally, the words may be in more than one different language.

In an embodiment, the body includes a plurality of design cutouts formed therein. The at least one design cutout, or plurality of design cutouts, may have a complex shape.

In an embodiment, the stencil apparatus is in a roll form.

In an embodiment, the body of the stencil apparatus may have a length from about 3 feet to about 16 feet. The body may also be about 9 feet long.

In an embodiment, the body has a width from about 3 inches to about 15 inches. The body may also be about 9 inches wide.

In yet another embodiment, a method for reusing a stencil apparatus is provided and includes providing a stencil apparatus having a body with front and back sides and at least one design cutout formed in the body, the back side of the body having a removable adhesive thereon, adhering at least a portion of the stencil apparatus to a first surface using the removable adhesive, applying a transfer medium to the first surface through the cutouts, removing the stencil apparatus from the first surface, and adhering the stencil apparatus to a second surface, wherein the method does not require removing a backing layer from the back side of the body to adhere the stencil apparatus.

In an embodiment, the second surface is the same as or different than the first surface.

In an embodiment, the adhesive is a removable hot melt acrylic adhesive.

In another embodiment, a method of transferring an image to a surface is provided. The method includes providing a stencil apparatus having a body with front and back sides and at least one design cutout formed in the body, the back side of the body having a removable adhesive thereon, adhering at least a portion of the stencil apparatus to a surface using the removable adhesive, wherein the adhering step does not require removing a backing layer from the back side of the body, and applying a transfer medium to the surface through the cutouts.

In an embodiment, the transfer medium is paint.

In still yet another embodiment, a method of manufacturing a stencil apparatus is provided. The method includes providing a roll of material comprising a first layer of paper stock having an adhesive on a bottom side, and a second layer of paper stock liner removably attached to the adhesive, applying a release coating to a top side of the first layer of paper stock, die-cutting the first layer of paper stock to form at least one design cutout therein, removing the second layer of paper stock liner and the design cutout from the first layer of paper stock, and rolling the first layer of paper stock having an adhesive on a bottom thereof to form a stencil roll. The stencil roll does not include a backing layer.

In an embodiment, the method further includes curing the release coating before die-cutting the first layer of paper stock.

In an embodiment, the method further includes rolling the first and second layers after die-cutting the first layer.

In an embodiment, the method further includes unrolling the first and second layers immediately prior to removing the second layer.

In an embodiment, the method further includes shrink-wrapping the stencil roll after rolling.

In an embodiment, the method further includes packaging the shrink-wrapped stencil roll.

In an embodiment, the first layer of paper stock is a 6.5 mil laser paper stock.

In an embodiment, the adhesive is a removable hot melt acrylic adhesive.

In an embodiment, the release coating comprises an ultraviolet cationic coating. In an embodiment, the release coating includes dimethysiloxanes and silicones.

An advantage of the present disclosure is to provide an improved stencil apparatus.

Another advantage of the present disclosure is to provide a stencil apparatus that does not require the use of a backing layer.

Yet another advantage of the present disclosure is to provide a stencil apparatus having an ultraviolet cationic flexographic release coating.

Still yet another advantage of the present disclosure is to provide a stencil apparatus having a layer of removable hot melt acrylic adhesive.

Another advantage of the present disclosure is to provide a stencil having complex design shapes formed therein.

An advantage of the present disclosure is to provide a stencil apparatus that is reusable.

Yet another advantage of the present disclosure is to provide a method for manufacturing an improved stencil apparatus.

Still yet another advantage of the present disclosure is to provide a method for using an improved stencil device to transfer an image to a surface using a transfer medium.

Additional features and advantages are described herein, and will be apparent from the following Detailed Description.

### BRIEF DESCRIPTION OF THE FIGURES

FIG. 1 shows an elevated front perspective view of a stencil apparatus in accordance with an embodiment of the present disclosure.

FIG. 2 shows a front plan view of a stencil apparatus in accordance with an embodiment of the present disclosure.

FIG. 3 shows an elevated back perspective view of a stencil apparatus in accordance with an embodiment of the present disclosure.

FIG. 4 shows a top plan view of a stencil apparatus in accordance with an embodiment of the present disclosure.

### DETAILED DESCRIPTION

The present disclosure provides reusable apparatuses for transferring an image to a working surface using a transfer medium. More specifically, the present disclosure relates to stencil apparatuses, and methods of making and using same. a stencil apparatus includes a body having front and back sides and at least one design cutout formed in the body, a removable adhesive on the back side of the body, and a release coating on the front side of the body. The stencil apparatus does not require a backing layer (e.g., a liner) to prevent the adhesive from sticking to a front side of the body when the stencil apparatus is rolled up. In another general embodiment, a reusable stencil apparatus includes a body having front and back sides and at least one design cutout formed in the body, a removable adhesive on the back side of the body, and a release coating on the front side of the body, the release coating comprised, in part, of an ultraviolet cationic coating.

Applicant has surprisingly found that by using at least a removable adhesive with a release coating, a reusable stencil apparatus may be provided. By providing the removable adhesive with a release coating, a stencil apparatus of the present disclosure may be manufactured without the need for a backing layer to prevent the adhesive from sticking to inappropriate surfaces prior to use thereof. Such reusable stencil apparatuses provide several advantages over prior art stencils.

For example, the stencil apparatuses of the present disclosure do not require the use of a removable backing layer to prevent the adhesive layer from sticking to inappropriate surfaces prior to use thereof. Instead, the combination of at least the removable adhesive and the release coating allows the stencil apparatus to be easily removed from both itself when, for example, in a roll form, and from working surfaces to which it is applied. By avoiding the use of a backing layer with the present stencil apparatuses, manufacturing and shipping costs will be decreased. Additionally, a consumer will more easily and efficiently use the stencil rolls since the removal of an extra backing layer is not required.

In addition to a roll form, the stencil apparatuses may also be condensed in size for packing or storage by any means known in the art. For example, the stencil apparatuses may be folded or otherwise condensed in size for storage prior to reuse of the stencil apparatuses. The skilled artisan will appreciate that the stencil apparatuses may be stored or packaged in any form known in the art for such apparatuses. As such, the skilled artisan will appreciate that the stencil roll need not be rolled up after use.

Further, a stencil apparatus of the present disclosure may be rolled up into a roll form for packaging, shipment or storage, but will be easily unrolled for use without sticking to itself and causing damage to the body or cutouts of the stencil apparatus. As will be discussed below, the cutouts of the present stencil apparatuses may have complex shapes and designs that require very thin or small portions of a body of the stencil apparatus to be peeled away from the remaining portion of the stencil apparatus to unroll the apparatus. Because the removable adhesive and release coat work with each other to provide easy release of the body from itself, such thin or small portions of the body will not be torn, ripped, or otherwise damaged during unrolling of the stencil apparatus.

Moreover, the adhesive on the back side stencil apparatus is sufficiently sticky to allow the stencil apparatus to securely stick to a working surface during use, but to also be easily removed from the working surface after use. The adhesive is uniquely formulated such that the stencil apparatus may be easily removed from a surface after use without damaging the surface to which it was adhered, without leaving any adhesive behind on the surface, and without damaging the stencil apparatus (e.g., tearing or ripping the stencil apparatus).

Once the stencil apparatus has been removed from the working surface, the stencil apparatus may be easily rolled up for storage until the stencil apparatus is required for use again. Despite prior use of the stencil apparatus, the adhesive remains sufficiently sticky so as to allow the stencil apparatus to remain in a rolled position, but to easily release from itself prior to the next use of the stencil apparatus.

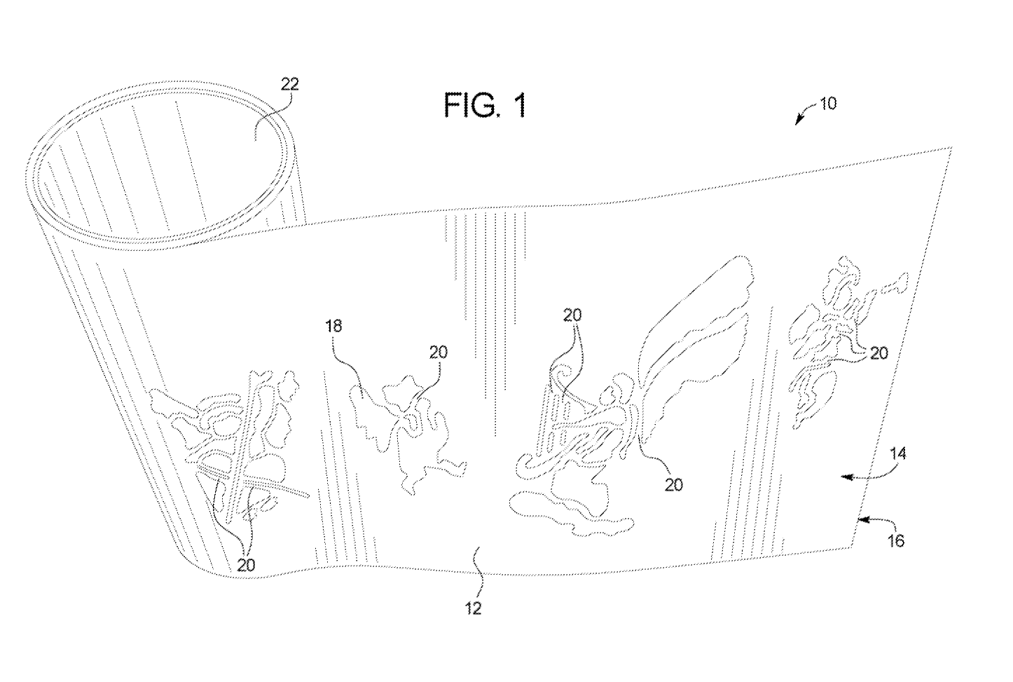

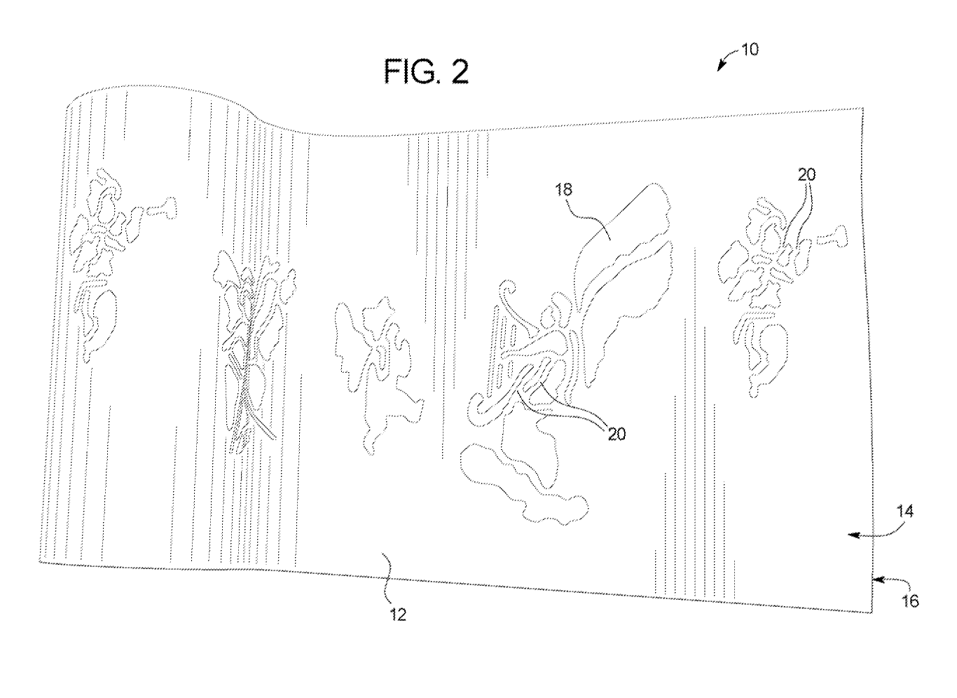

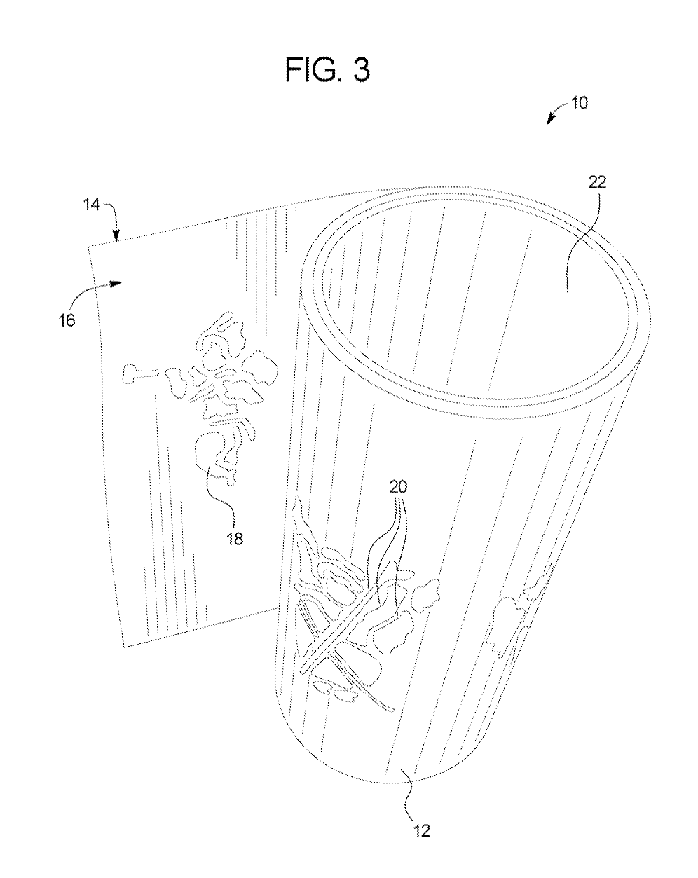

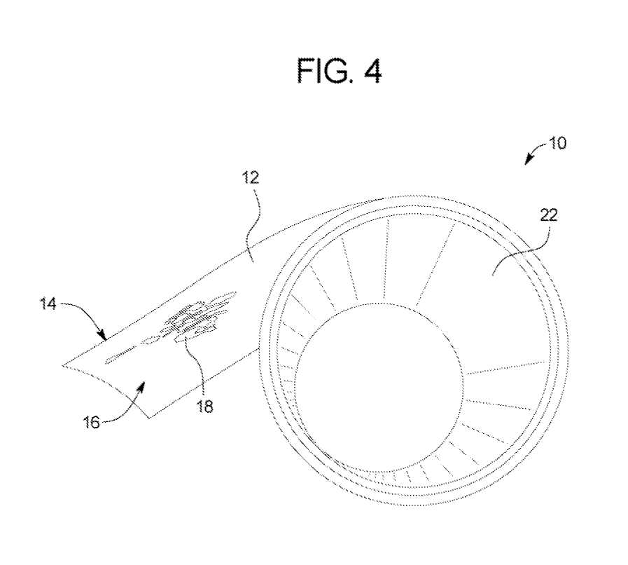

FIGS. 1-4 show embodiments of a stencil apparatus 10 of the present disclosure. Stencil apparatus 10 includes a body 12 having a front side 14, a back side 16, and at least one cutout 18 formed therein. Body 12 may be formed from any sufficiently strong paper material including stock paper, card stock, cover stock, pasteboard, vellum, etc. In an embodiment, body 12 is made from 6.5 mil white laser stock paper. The skilled artisan will appreciate that the body may be any size known in the art to accomplish the transfer of a transfer medium through cutouts 18 of body 12 to a working surface. In an embodiment, however, body 12 of stencil apparatus 10 has a length from about 3 feet to about 15 feet. Body 12 may also be about 9 feet long. Body 12 may have a width from about 3 inches to about 15 inches, or may be about 9 inches wide.

Front side 14 of body 12 includes a layer of a release coating (not shown) that allows stencil apparatus 10 to be in a roll form such that a portion of front side 14 of body 12 contacts a portion of back side 16 of body 12 prior to unwinding of stencil apparatus 10. The release coating may be a release coating that allows a removable adhesive to easily remove from the release coating on front side 14 of body 12. As discussed above, a removable adhesive must be easily removed from the release coating on front side 14 of body 12 such that body 12, or any cutout 18 formed therein, is not damaged (e.g., torn or ripped) when front side 14 and back side 16 of body 12 are pulled away from each other.

FIGS. 1 and 3-4 illustrate that stencil apparatus 10 may be in a roll form and may be rolled onto any base 22 for carrying and/or supporting a material rolled thereon. For example, base 22 may be made of cardboard, paper stock, card stock, etc. The skilled artisan will appreciate that any material may be used for base 22 so long as base 22 is able to support several feet of body 12 rolled thereon.

The release coat may be applied to front side 14 of body 12 in any amount necessary to provide the advantages discussed herein. In an embodiment, the release coating is a flexographic release coating that is applied using a #600 Anilox roller, which determines the amount and thickness of the release coating applied to front side 14 of body 12. The release coating includes dimethysiloxanes and silicones. The methods for applying the release coating will be discussed further below.

Back side 16 of body 12 includes a removable adhesive layer (not shown) that may be used to removably adhere stencil apparatus 10 to a working surface, or to adhere a portion of back side 16 of body 12 to a portion of front side 14 of body 12 when stencil apparatus 10 is in a roll form. Specifically, the adhesive may be an adhesive that allows stencil apparatus 10 to be easily removed from both itself when in a roll form and working surfaces to which it is applied. The adhesive should also allow stencil apparatus 10 to be easily unrolled for use without sticking to itself and causing damage to body 12 or cutouts 18 of stencil apparatus 10. Moreover, the adhesive on back side 16 of body 12 of stencil apparatus 10 should be sufficiently sticky to allow stencil apparatus 10 to securely stick to a working surface during use, but to be easily removed from the working surface after use without damaging the surface to which it was adhered, without leaving any adhesive behind on the surface, and without damaging stencil apparatus 10 (e.g., tearing or ripping any portion of the stencil apparatus).

Acrylic hot melt adhesives are useful in the production of tapes, labels, and decals having superior weathering and solvent resistance to similar adhesives prepared from conventional styrene/diene block copolymers. The ability of these adhesives to be applied from the melt and their excellent creep resistance gives them significant performance and processing advantages over conventional solvent and emulsion based acrylic pressure sensitive adhesives. In an embodiment, the removable adhesive is a hot melt acrylic adhesive. The removable adhesive may be applied to back side 16 of body 12 in any amount suitable to provide the advantages discussed above. For example, the removable adhesive may be applied as a layer or coating on back side 16 of body 12 and may have a thickness from about 0.5 mil to about 2 mil. In an embodiment, the removable adhesive has a thickness of about 1.0 mil.

Once stencil apparatus 10 has been removed from the working surface, stencil apparatus 10 may be easily rolled up for storage until stencil apparatus 10 is required for use again. Despite prior use of stencil apparatus 10, the adhesive remains sufficiently sticky so as to allow stencil apparatus 10 to remain in a rolled position, but to easily release from itself prior to the next use of stencil apparatus 10.

As is illustrated in FIGS. 1-4, at least one cutout 18 is formed in body 12. In an embodiment, a plurality of cutouts 18 are formed in body 12. Cutouts 18 may be formed in body 12 at regular, random or pre-determined intervals. Cutouts 18 may be present in a repeating pattern or a random pattern along any portion of body 12, or along the entire length of body 12. Cutouts may be formed in body 12 of the stencil apparatus 10 by kiss-cutting, or die-cutting, body 12, or by other well-known methods, as will be discussed further below.

Cutouts 18 may be arranged in any manner, such as to form a design pattern comprising a plurality of cutouts 18. For example, the cutouts 18 may form a design or shape comprised of several separate cutouts in body 12, as is shown with the angel-shaped cutouts 18 of FIGS. 1-4. Alternatively, one cutout 18 may comprise an entire shape or design. Cutouts 18 allow a transfer medium to be applied to a working surface in the shape of cutouts 18 such that the transfer medium in the shape of cutouts 18 remains on a surface after stencil apparatus 10 is removed from the surface.

Although illustrated in FIGS. 1-4 as having an angel shape and pattern, the skilled artisan will appreciate that cutouts 18 may have any known shape. For example, cutouts 18 may have a shape associated with a theme including, for example, geometric, religious, animals, people, nature, vehicles, buildings, sports, food, seasonal decorations, special occasion decorations, and similar themes. Cutouts 18, however, are not limited solely to shapes associated with these themes.

Further, the skilled artisan will appreciate that several recognizable shapes are known within each of these themes. For example, when the shape is associated with a geometric theme, the shape may be, for example, a circle, square, triangle, rectangle, oval, ellipse, semi-circle, and similar shapes. When the shape is associated with a religious theme, the shape may be, for example, a cross, bible, star of David, angels, trumpets, wreaths, fish, menorah, dove, candle, star and crescent, om, Buddha, and similar shapes. When the shape is associated with a sports theme, the shape may be, for example, a baseball, bat, baseball hat, baseball glove, basketball, basketball hoop, football, football goal post, football helmet, golf ball, golf club, lacrosse stick, and similar shapes. The skilled artisan will appreciate that cutouts 18 may have any known shape desired by a consumer.

In an embodiment, the cutouts may be in the shape of words or numbers. For example, a stencil apparatus designed for decorating for a birthday celebration may include the phrase “Happy Birthday” and have a cutout in the shape of a birthday cake or a present. Similarly, a stencil apparatus designed for decorating for an anniversary celebration may include the phrase “Congratulations!” followed by a cutout in the shape of two wedding bands and followed by a cutout that says “50 Years!”.

Additionally, the words may be in more than one different language. The languages may include, for example, English, Spanish, French, German, etc. The skilled artisan will appreciate that any language may be used to create word cutouts. For example, in an embodiment, a stencil apparatus intended for use in a school room may include cutouts that read “one, two, three” followed by another set of words that reads “uno, dos, tres” and followed by another set of words that reads “un, deux, trois.” Similarly, a stencil apparatus intended for use in a school room may also read “hello, hola, salut.” The skilled artisan will appreciate that any combinations of words and languages may be used with the present stencil apparatuses.

The cutouts may include numbers. For example, a stencil apparatus may include cutouts of the numbers 1 to 20 for stenciling the walls of a school room. Alternatively, the cutouts may read as equations. For example, a stencil apparatus may include a cutout that reads “2+2=4.” However, similar to embodiments previously discussed, the skilled artisan will appreciate that different combination of numbers or numbering systems may be used with the present stencil apparatuses.

The cutouts of the present stencil apparatuses may have complex shapes and designs that require very thin or small portions of a body of the stencil apparatus to be peeled away from the remaining portion of the stencil apparatus to unroll the apparatus. Accordingly, in an embodiment, cutouts 18 have a complex shape. As used herein, “complex shape” means a shape having at least one portion of the shape that is sufficiently small and intricate so as to be susceptible to ripping, tearing or otherwise damaged during packaging, storage or use of stencil apparatus 20.

In an embodiment, for example, a complex shape may have at least two separate components necessary to complete the shape such that the separate components do not share a common border and at least a portion of body 12 is a sufficiently small and intricate portion of the total shape so as to be susceptible to ripping, tearing or otherwise being damaged. For example, as shown in FIGS. 1-4, an angel cutout 18 may have any number of very thin portions 20 that are susceptible to damage upon unrolling of stencil apparatus 10. However, because the removable adhesive and release coat work with each other to provide easy release of body 12 from itself, such thin or small portions of body 12 will not be torn or ripped during unrolling of stencil apparatus 10.

In another embodiment, for example, a complex shape may be a shape having one continuous border with at least one extended portion having a width that is substantially smaller than an overall width of the total shape. For example, a sun cutout (not shown) may have a continuous outer border such that many rays of light extending from a center sun portion are represented by very thin portions that are susceptible to ripping, tearing or otherwise being damaged. Again, however, because the removable adhesive and release coat work with each other to provide easy release of body 12 from itself, such thin or small portions of body 12 will not be torn or ripped during unrolling of stencil apparatus 10.

Stencil apparatuses 10 of the present disclosure may be used in combination with a variety of surfaces, including, for example, wood, glass, fabric, metal, concrete, terra cotta, plaster, ceramics, plastics, candles, canvas, paper crafts such as cards, stationery, gift bags, envelopes, and combinations thereof. Accordingly, stencil apparatuses 10 may be used to transfer an image to, for example, walls, furniture, glassware, etc. The skilled artisan will appreciate that any surface may be used in combination with stencil apparatuses 10 so long as the stencil apparatuses 10 may be removably adhered thereto.

The transfer medium used to transfer an image to a surface using the stencil apparatuses 10 of the present disclosure may include, for example, flat paint, satin paint, matte paint, semi gloss paint, hi gloss paint, interior and exterior paints, acrylic paint, Krylon® spray paints, Delta® perm enamel, Pebeo™ glass paint, fabric paints, fabric markers, fabric crayons, metal paints, outdoor paints, ceramic glazes, ceramic markers, ceramic pens, ceramic paints, candle paint mediums, oil paints, stamp ink, markers, embossing powders, pens, pencils, chalk, and combinations thereof. The skilled artisan will appreciate that any transfer medium may be used in combination with stencil apparatuses 10 so long as the transfer medium properly transfers to the surface.

Due, in part, to the unique combination of removable adhesive, release coating and body material, the above described stencil apparatuses may be reused several times. Methods for reusing stencil apparatuses of the present disclosure include providing a stencil apparatus having a body with front and back sides and at least one design cutout formed in the body, unrolling the stencil apparatus, adhering at least a portion of the stencil apparatus to a surface using the removable adhesive, applying a transfer medium to the surface through the cutouts, removing the stencil apparatus from the surface, and re-rolling the stencil apparatus. The back side of the body includes a removable adhesive thereon that allows the stencil apparatus to adhere to itself in a roll form, as well as to a surface for use in transferring an image to the surface. As discussed in detail above, methods for using and reusing the stencil apparatuses of the present disclosure do not require removing a backing layer from the back side of the body.

Similarly, methods for transferring an image to a surface using stencil apparatuses of the present disclosure are provided. The methods generally include providing a stencil apparatus having a body with front and back sides and at least one design cutout formed in the body, adhering at least a portion of the stencil apparatus to a surface using the removable adhesive, and applying a transfer medium to the surface through the cutouts. The back side of the body includes a removable adhesive thereon, and the adhering step does not require removing a backing layer from the back side of the body.

Methods of manufacturing stencil apparatuses of the present disclosure are also provided. The methods generally include providing a roll of material comprising a first layer of paper stock having an adhesive on a bottom side, and a second layer of paper stock liner removably attached to the adhesive, applying a flexographic release coating to a top side of the first layer of paper stock, die-cutting the first layer of paper stock to form at least one design cutout therein, removing the second layer of paper stock liner and the design cutout from the first layer of paper stock, and rolling the first layer of paper stock having an adhesive on a bottom thereof to form a stencil roll.

More specifically, starting materials for stencil apparatuses of the present disclosure may include three layers. The first layer is a material that is used to form, in part, the body of the stencil apparatuses. The first layer material may be a paper product such as, but not limited to stock paper. In an embodiment, the stock paper is 6.5 mil while laser paper stock. The second layer is an adhesive that is applied to a bottom side of the first layer. The adhesive may be any adhesive described herein above. In an embodiment, the adhesive is a removable hot melt acrylic and the adhesive layer is about 1 mil thick. The third layer of the starting materials is a bottom layer with a silicone release on the top side thereof that interacts with the adhesive layer. The bottom layer acts as a liner that is attached to the starting materials for ease in removing cutout portions, as will be discussed further below. The bottom liner layer may also be a stock paper. In an embodiment, the bottom liner layer is a 53# white paper stock with a silicone release layer on a top side. This bottom layer does not stay with the final product and is removed during the converting processes described below, along with the cutout portions.

A first converting stage of the manufacturing process includes application of the release coating and die-cutting of the starting materials. Generally speaking, and to begin this process, the roll of raw materials (e.g., the three layered roll described above) is unrolled using a converting roll/wheel set-up. Upon unrolling of the raw materials, a release coating is applied to the top of the first layer and cured almost immediately thereafter. A few feet down the product line (e.g., 3-7 feet away), the materials are cut using a rotary die-cutter. About 10-20 feet down the product line, the materials (including the third liner layer) are re-rolled to form a stencil apparatus in a roll form. The stencil apparatus roll is then taken to a finishing department where the roll is again unwound using a roll converter, and, almost simultaneously, the third liner layer is removed and the roll is re-rolled to form a final stencil apparatus.

More specifically, and in an embodiment, the release coating is a flexographic release coating. Flexography is known in the art and is a form of printing process which utilizes a flexible relief plate. Flexography can be used for printing on almost any type of substrate including plastic, metallic films, cellophane, paper, etc.

The flexographic release coating is applied using #600 anilox rollers and is cured with a 400 Watt ultraviolet light. Anilox rollers are known in the art and are hard cylinders, usually constructed of a steel or aluminum core that are coated by an industrial ceramic whose surface contains millions of very fine dimples, known as cells. This texture holds a specific amount of ink since it's covered with thousands of small wells or cups that enable it to meter ink to the printing plate in a uniform thickness evenly and quickly (the number of cells per linear inch can vary according to the type of print job and the quality required). Ultimately, the characteristics of an anilox roll that determine the amount of ink or adhesive that will be transferred to the plate include, for example, the angle of the cells, cell volume, and line screen.

The flexographic release coating is cured immediately after it is applied using a 400 Watt ultraviolet light. The curing occurs almost instantaneously. In an embodiment, the curing occurs in about 1 to about 4 seconds.

After the flexographic release coating is cured, the materials proceed to cutting where the cutouts are formed in the body of the stencil apparatus. The cutouts are generally formed by kiss-cutting through the first stock paper layer and adhesive, but not the third liner layer. In an embodiment, the cutouts are formed using a magnetic cylinder with a steel rule die. The cylinder is rolled over the material to form any cutout shape as discussed above. After the cutouts are formed, the materials are rolled up with the third liner layer still in tact. The materials may be inspected at this point to ensure that the rolled materials meet certain specifications.

In a second converting stage, the roll having the third layer still in tact is taken to a rewind station where the roll is unwound, the third liner layer is removed, and the remaining materials are rewound into a roll form to make a finished stencil apparatus. When the third liner layer is removed from the materials, the cutout portions are removed therewith to leave voids in the body of the stencil apparatus that form the cutouts 18 discussed above. In an embodiment, the finished stencil apparatus roll may be about 9 inches by 9 feet. The materials may also be inspected at this point to ensure the final products meet certain specifications. Each individual stencil roll apparatus may be shrink-wrapped and packaged in cases for distribution.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A reusable stencil apparatus comprising:
a body having front and back sides and at least one design cutout formed in the body;
a removable adhesive on the back side of the body; and
a release coating on the front side of the body, the release coating comprising an ultraviolet cationic coating.

2. The stencil apparatus of claim 1, wherein the body comprises stock paper.

3. The stencil apparatus of claim 2, wherein the stock paper is 6.5 mil white laser stock paper.

4. The stencil apparatus of claim 1, wherein the removable adhesive is a hot melt acrylic adhesive.

5. The stencil apparatus of claim 1, wherein the removable adhesive forms a layer on the back side of the body and has a thickness of about 0.5 to about 2 mil.

6. The stencil apparatus of claim 5, wherein the removable adhesive layer is about 1 mil thick.

7. The stencil apparatus of claim 1, wherein the release coating forms a layer on the front side of the body and has a thickness of about 0.1 to about 0.5 mil.

8. The stencil apparatus of claim 7, wherein the release coating layer is about 0.2 to 0.3 mils thick.

9. The stencil apparatus of claim 1, wherein the cutouts have a shape associated with a theme that is at least one of geometric, religious, animals, people, nature, vehicles, buildings, sports, food, seasonal decorations, and special occasion decorations.

10. The stencil apparatus of claim 9, wherein the shape associated with the geometric theme is at least one of a circle, square, triangle, rectangle, oval, ellipse, and semi-circle.

11. The stencil apparatus of claim 9, wherein the shape associated with the religious theme is at least one of a cross, bible, star of David, angels, trumpets, wreaths, fish, menorah, dove, candle, star and crescent, om, and Buddha.

12. The stencil apparatus of claim 9, wherein the shape associated with the sports theme is at least one of a baseball, bat, baseball hat, baseball glove, basketball, basketball hoop, football, football goal post, football helmet, golf ball, golf club, and lacrosse stick.

13. The stencil apparatus of claim 1, wherein the design cutout is at least one of a word, a number, and combinations of words and numbers.

14. The stencil apparatus of claim 1, wherein the body comprises a plurality of design cutouts formed therein.

15. The stencil apparatus of claim 1, wherein the at least one design cutout comprises a complex shape.

16. The stencil apparatus of claim 1, wherein the stencil apparatus is in a roll form.

17. The stencil apparatus of claim 1, wherein the body has a length from about 3 feet to about 15 feet.

18. The stencil apparatus of claim 17, wherein the body has a length that is about 9 feet.

19. The stencil apparatus of claim 1, wherein the body has a width from about 3 inches to about 15 inches.

20. The stencil apparatus of claim 19, wherein the body has a width that is about 9 inches.

21. A reusable stencil apparatus comprising:
a body having front and back sides and at least one design cutout formed in the body;
a removable adhesive on the back side of the body; and
a release coating on the front side of the body,
wherein the body does not require a backing layer to prevent the adhesive from sticking to a portion of the body.

22. The stencil apparatus of claim 21, wherein the body comprises stock paper.

23. The stencil apparatus of claim 22, wherein the stock paper is 6.5 mil white laser stock paper.

24. The stencil apparatus of claim 21, wherein the removable adhesive is a hot melt acrylic adhesive.

25. The stencil apparatus of claim 21, wherein the removable adhesive forms a layer on the back side of the body and has a thickness of about 0.5 to about 2 mil.

26. The stencil apparatus of claim 25, wherein the removable adhesive layer is about 1 mil thick.

27. The stencil apparatus of claim 21, wherein the release coating forms a layer on the front side of the body and has a thickness of about 0.1 to about 0.5 mil.

28. The stencil apparatus of claim 27, wherein the release coating layer is about 0.2 to 0.3 mils thick.

29. The stencil apparatus of claim 21, wherein the cutouts have a shape associated with a theme that is at least one of geometric, religious, animals, people, nature, vehicles, buildings, sports, food, seasonal decorations, and special occasion decorations.

30. The stencil apparatus of claim 29, wherein the shape associated with the geometric theme is at least one of a circle, square, triangle, rectangle, oval, ellipse, and semi-circle.

31. The stencil apparatus of claim 29, wherein the shape associated with the religious theme is at least one of a cross, bible, star of David, angels, trumpets, wreaths, fish, menorah, dove, candle, star and crescent, om, and Buddha.

32. The stencil apparatus of claim 29, wherein the shape associated with the sports theme is at least one of a baseball, bat, baseball hat, baseball glove, basketball, basketball hoop, football, football goal post, football helmet, golf ball, golf club, and lacrosse stick.

33. The stencil apparatus of claim 21, wherein the design cutout is at least one of a word, a number, and combinations of words and numbers.

34. The stencil apparatus of claim 21, wherein the body comprises a plurality of design cutouts formed therein.

35. The stencil apparatus of claim 21, wherein the at least one design cutout comprises a complex shape.

36. The stencil apparatus of claim 21, wherein the stencil apparatus is in a roll form.

37. The stencil apparatus of claim 21, wherein the body has a length from about 3 feet to about 15 feet.

38. The stencil apparatus of claim 37, wherein the body has a length that is about 9 feet.

39. The stencil apparatus of claim 21, wherein the body has a width from about 3 inches to about 15 inches.

40. The stencil apparatus of claim 39, wherein the body has a width that is about 9 inches.

41. A method for reusing a stencil apparatus, the method comprising:
providing a stencil apparatus having a body with front and back sides and at least one design cutout formed in the body, the back side of the body having a removable adhesive thereon;
adhering at least a portion of the stencil apparatus to a first surface using the removable adhesive;
applying a transfer medium to the first surface through the cutouts;
removing the stencil apparatus from the first surface; and
adhering the stencil apparatus to a second surface, wherein the method does not require removing a backing layer from the back side of the body to adhere the stencil apparatus.

42. The method of claim 41, wherein the adhesive is a removable hot melt acrylic adhesive.

43. The method of claim 41, wherein the cutout has a shape associate with a theme that is at least one of geometric, religious, animals, people, nature, vehicles, buildings, sports, food, seasonal decorations, and special occasion decorations.

44. The method of claim 43, wherein the shape associated with the geometric theme is at least one of a circle, square, triangle, rectangle, oval, ellipse, and semi-circle.

45. The method of claim 43, wherein the shape associated with the religious theme is at least one of a cross, bible, star of David, angels, trumpets, wreaths, fish, menorah, dove, candle, star and crescent, om, and Buddha.

46. The method of claim 43, wherein the shape associated with the sports theme is at least one of a baseball, bat, baseball hat, baseball glove, basketball, basketball hoop, football, football goal post, football helmet, golf ball, golf club, and lacrosse stick.

47. The method of claim 41, wherein the design cutout is at least one of a word, a number, and combinations of words and numbers.

48. The method of claim 41, wherein the body comprises a plurality of design cutouts formed therein.

49. The method of claim 41, wherein the at least one design cutout comprises a complex shape.

50. The method of claim 41, wherein the second surface is the same as or different than the first surface.

51. A method of transferring an image to a surface, the method comprising:
providing a stencil apparatus having a body with front and back sides and at least one design cutout formed in the body, the back side of the body having a removable adhesive thereon;
adhering at least a portion of the stencil apparatus to a surface using the removable adhesive, wherein the adhering step does not require removing a backing layer from the back side of the body; and
applying a transfer medium to the surface through the cutouts.

52. The method of claim 51, wherein the adhesive is a removable hot melt acrylic adhesive.

53. The method of claim 51, wherein the cutout has a shape associated with a theme that is at least one of geometric, religious, animals, people, nature, vehicles, buildings, sports, food, seasonal decorations, and special occasion decorations.

54. The method of claim 53, wherein the shape associated with the geometric theme is at least one of a circle, square, triangle, rectangle, oval, ellipse, and semi-circle.

55. The method of claim 53, wherein the shape associated with the religious theme is at least one of a cross, bible, star of David, angels, trumpets, wreaths, fish, menorah, dove, candle, star and crescent, om, and Buddha.

56. The method of claim 53, wherein the shape associated with the sports theme is at least one of a baseball, bat, baseball hat, baseball glove, basketball, basketball hoop, football, football goal post, football helmet, golf ball, golf club, and lacrosse stick.

57. The method of claim 51, wherein the design cutout is at least one of a word, a number, and combinations of words and numbers.

58. The method of claim 51, wherein the body comprises a plurality of design cutouts formed therein.

59. The method of claim 51, wherein the at least one design cutout comprises a complex shape.

60. The method of claim 51, wherein the transfer medium is paint.

61. A method of manufacturing a stencil apparatus, the method comprising:
providing a roll of material comprising a first layer of paper stock having an adhesive on a bottom side, and a second layer of paper stock liner removably attached to the adhesive;
applying a release coating to a top side of the first layer of paper stock;
die-cutting the first layer of paper stock to form at least one design cutout therein;
removing the second layer of paper stock liner and the design cutout from the first layer of paper stock;
rolling the first layer of paper stock having an adhesive on a bottom thereof to form a stencil roll, wherein the stencil roll does not include a backing layer.

62. The method of claim 61 further comprising curing the release coating before die-cutting the first layer of paper stock.

63. The method of claim 61 further comprising rolling the first and second layers after die-cutting the first layer.

64. The method of claim 61 further comprising unrolling the first and second layers immediately prior to removing the second layer.

65. The method of claim 61 further comprising shrink-wrapping the stencil roll after rolling.

66. The method of claim 61 further comprising packaging the shrink-wrapped stencil roll.

67. The method of claim 61, wherein the first layer of paper stock is a 6.5 mil laser paper stock.

68. The method of claim 61, wherein the adhesive is a removable hot melt acrylic adhesive.

69. The method of claim 61, wherein the release coating comprises an ultraviolet cationic coating.
